(19) United States
(12) Patent Application Publication
(10) Pub. No.: US 2026/0208102 A1
(43) Pub. Date: Jul. 23, 2026

(54) DISCHARGE GAS TREATMENT METHOD AND DISCHARGE GAS TREATMENT DEVICE

(71) Applicant: Resonac Corporation, Tokyo (JP)

(72) Inventors: Kunchan LEE, Tokyo (JP); Kazuki IWAGAKI, Tokyo (JP)

(73) Assignee: Resonac Corporation, Tokyo (JP)

(21) Appl. No.: 19/140,416

(22) PCT Filed: Dec. 12, 2023
(86) PCT No.: PCT/JP2023/044416

§ 371 Date: Jun. 18, 2025

(30) Foreign Application Priority Data
Dec. 19, 2022 (JP) 2022-202042

(51) Int. Cl. B01D 53/75; B01D 53/68; B01D 53/78; B01D 53/86; B01J 23/00; B01J 23/755; B01J 23/83; B01J 37/00; B01J 37/08

(52) U.S. Cl. CPC B01D 53/75; B01D 53/68; B01D 53/78; B01D 53/8662; B01D 53/869; B01J 23/002; B01J 23/755; B01J 23/83; B01J 37/0009; B01J 37/08; B01D 2255/2065; B01D 2255/20746; B01D 2255/20753; B01D 2255/20761; B01D 2255/2092; B01D 2255/40; B01D 2257/2025; B01D 2257/2045; B01D 2257/2066; B01D 2258/0216; B01J 2523/17; B01J 2523/31; B01J 2523/3712; B01J 2523/845

(57) ABSTRACT

Provided is a discharge gas treatment method capable of decomposing chlorine gas and a perfluorocompound in a discharge gas containing the chlorine gas and the perfluorocompound, resulting in a gas having a low chlorine gas concentration and a low perfluorocompound concentration. The discharge gas treatment method is a method of treating a discharge gas containing chlorine gas and a perfluorocompound and includes a chlorine gas decomposition step of decomposing the chlorine gas in the discharge gas by thermally reacting the chlorine gas with water, a hydrogen chloride removal step of removing hydrogen chloride from the gas after the chlorine gas decomposition step, and a perfluorocompound decomposition step of decomposing the perfluorocompound in the gas after the hydrogen chloride removal step by reacting the perfluorocompound in the presence of a perfluorocompound decomposition catalyst.

### TECHNICAL FIELD

The present invention relates to a discharge gas treatment method and a discharge gas treatment device.

### BACKGROUND ART

During production of semiconductors, a discharge gas containing chlorine gas and perfluorocompounds (PFC) may be discharged. There is therefore a demand for a treatment method of decomposing both chlorine gas and perfluorocompounds in a discharge gas to result in low concentrations. For example, PTL 1 discloses a treatment device. With the device, a discharge gas is introduced to a reactor filled with a chlorine gas decomposition catalyst and a perfluorocompound decomposition catalyst, and both chlorine gas and perfluorocompounds are simultaneously decomposed.

### CITATION LIST

### Patent Literature

PTL 1: WO 2022/138850

### SUMMARY OF INVENTION

### Technical Problem

There is still a demand for an improvement in the removal efficiency of decomposing and removing chlorine gas from a discharge gas.

The present invention is intended to provide a discharge gas treatment method and a discharge gas treatment device capable of decomposing chlorine gas and a perfluorocompound in a discharge gas containing the chlorine gas and the perfluorocompound, resulting in a gas having a low chlorine gas concentration and a low perfluorocompound concentration.

### Solution to Problem

To solve the problems, aspects of the present invention are the following [1] to [10].
[1] A method of treating a discharge gas containing chlorine gas and a perfluorocompound, the discharge gas treatment method including a chlorine gas decomposition step of decomposing the chlorine gas in the discharge gas by thermally reacting the chlorine gas with water, a hydrogen chloride removal step of removing hydrogen chloride from a gas after the chlorine gas decomposition step, and a perfluorocompound decomposition step of decomposing the perfluorocompound in a gas after the hydrogen chloride removal step by reacting the perfluorocompound in the presence of a perfluorocompound decomposition catalyst.
[2] The discharge gas treatment method according to the aspect [1], in which the perfluorocompound decomposition step is a step of decomposing the perfluorocompound in the gas after the hydrogen chloride removal step by reacting the perfluorocompound in the presence of the perfluorocompound decomposition catalyst and of decomposing the chlorine gas in the gas after the hydrogen chloride removal step by reacting the chlorine gas in the presence of a chlorine gas decomposition catalyst.
[3] The discharge gas treatment method according to the aspect [1] or [2], in which the hydrogen chloride removal step is a step of removing the hydrogen chloride by bringing the gas after the chlorine gas decomposition step into contact with water to dissolve the hydrogen chloride in the water.
[4] The discharge gas treatment method according to any one of the aspects [1] to [3], in which in the chlorine gas decomposition step, the chlorine gas is reacted and decomposed at a temperature of 700° C. or more and 850° C. or less.
[5] The discharge gas treatment method according to any one of the aspects [1] to [4], in which in the perfluorocompound decomposition step, the perfluorocompound is reacted and decomposed at a temperature of 500° C. or more and 800° C. or less.
[6] A device of treating a discharge gas containing chlorine gas and a perfluorocompound, the discharge gas treatment device including
a chlorine gas decomposition unit configured to decompose the chlorine gas in the discharge gas by thermally reacting the chlorine gas with water,
a hydrogen chloride removal unit configured to remove hydrogen chloride from a gas in which the chlorine gas has been decomposed by using the chlorine gas decomposition unit, and
a perfluorocompound decomposition unit containing a perfluorocompound decomposition catalyst, the perfluorocompound decomposition unit being configured to decompose the perfluorocompound in a gas from which the hydrogen chloride has been removed by using the hydrogen chloride removal unit, by reacting the perfluorocompound in the presence of the perfluorocompound decomposition catalyst.
[7] The discharge gas treatment device according to the aspect [6], in which the perfluorocompound decomposition unit contains the perfluorocompound decomposition catalyst and a chlorine gas decomposition catalyst and is configured to decompose the perfluorocompound in the gas from which the hydrogen chloride has been removed by using the hydrogen chloride removal unit, by reacting the perfluorocompound in the presence of the perfluorocompound decomposition catalyst and to decompose the chlorine gas in the gas from which the hydrogen chloride has been removed by using the hydrogen chloride removal unit, by reacting the chlorine gas in the presence of the chlorine gas decomposition catalyst.
[8] The discharge gas treatment device according to the aspect [6] or [7], in which the hydrogen chloride removal unit is configured to remove the hydrogen chloride by bringing the gas in which the chlorine gas has been decomposed by using the chlorine gas decomposition unit, into contact with water to dissolve the hydrogen chloride in the water.
[9] The discharge gas treatment device according to any one of the aspects [6] to [8], in which the chlorine gas decomposition unit is configured to react and decompose the chlorine gas at a temperature of 700° C. or more and 850° C. or less.
[10] The discharge gas treatment device according to any one of the aspects [6] to [9], in which the perfluorocompound decomposition unit is configured to react and decompose the perfluorocompound at a temperature of 500° C. or more and 800° C. or less.

### Advantageous Effects of Invention

According to the present invention, chlorine gas and a perfluorocompound in a discharge gas containing the chlorine gas and the perfluorocompound are decomposed to result in a gas having a low chlorine gas concentration and a low perfluorocompound concentration.

### BRIEF DESCRIPTION OF DRAWINGS

FIG. 1 is a schematic diagram illustrating an example discharge gas treatment device configured to perform the discharge gas treatment method pertaining to the present invention.

### DESCRIPTION OF EMBODIMENTS

Embodiments of the present invention will now be described. The embodiments are merely examples of the present invention, and the present invention is not limited to the embodiments. Various modifications or improvements can be made in the embodiments, and such modifications and improvements can be encompassed by the present invention.

The discharge gas treatment method pertaining to the present embodiment is a method of treating a discharge gas containing chlorine gas and a perfluorocompound and includes a chlorine gas decomposition step of decomposing the chlorine gas in the discharge gas by thermally reacting the chlorine gas with water, a hydrogen chloride removal step of removing the hydrogen chloride from the gas after the chlorine gas decomposition step, and a perfluorocompound decomposition step of decomposing the perfluorocompound in the gas after the hydrogen chloride removal step by reacting the perfluorocompound in the presence of a perfluorocompound decomposition catalyst.

The discharge gas treatment device pertaining to the present embodiment is a device of treating a discharge gas containing chlorine gas and a perfluorocompound and includes a chlorine gas decomposition unit configured to decompose the chlorine gas in the discharge gas by thermally reacting the chlorine gas with water, a hydrogen chloride removal unit configured to remove the hydrogen chloride from the gas in which the chlorine gas has been decomposed by using the chlorine gas decomposition unit, and a perfluorocompound decomposition unit containing a perfluorocompound decomposition catalyst and configured to decompose the perfluorocompound in the gas from which the hydrogen chloride has been removed by using the hydrogen chloride removal unit, by reacting the perfluorocompound in the presence of the perfluorocompound decomposition catalyst.

When chlorine gas (Cl₂) is reacted with water (H₂O) to undergo hydrolysis, hydrogen chloride (HCl) and oxygen gas (O₂) are generated as shown in the following reaction scheme.

Cl₂+H₂O→2HCl+½O₂

As the reaction is an equilibrium reaction, a higher hydrogen chloride concentration promotes the reaction opposite to the hydrolysis reaction, and hydrogen chloride is oxidized to regenerate chlorine gas. Hence, to suppress the regeneration of chlorine gas and to lower the concentration of chlorine gas in the gas, it is necessary to remove the hydrogen chloride generated by the hydrolysis of chlorine gas.

The discharge gas treatment method pertaining to the present embodiment includes the chlorine gas decomposition step followed by the hydrogen chloride removal step, and thus chlorine gas is unlikely to be regenerated after the hydrogen chloride removal step. In the perfluorocompound decomposition step after the hydrogen chloride removal step, the perfluorocompound is removed from the gas from which the hydrogen chloride has been removed, and thus the resulting gas has a low chlorine gas concentration and a low perfluorocompound concentration.

The discharge gas treatment device pertaining to the present embodiment includes the hydrogen chloride removal unit configured to remove hydrogen chloride from the gas in which the chlorine gas has been decomposed by using the chlorine gas decomposition unit, and thus chlorine gas is unlikely to be regenerated in the gas from which hydrogen chloride has been removed by using the hydrogen chloride removal unit. The discharge gas treatment device pertaining to the present embodiment further includes the perfluorocompound decomposition unit, and thus the resulting gas has a low chlorine gas concentration and a low perfluorocompound concentration.

For example, the gas after the decomposition of the perfluorocompound has a chlorine gas concentration of 1.0 volume ppm or less relative to 100 to 10,000 volume ppm of the chlorine gas concentration in the discharge gas, and the gas after the decomposition of the perfluorocompound has a perfluorocompound concentration of 50 volume ppm or less relative to 1,000 to 10,000 volume ppm of the perfluorocompound concentration in the discharge gas.

The discharge gas treatment method and the discharge gas treatment device pertaining to the present embodiment will next be described in further detail.

### [Discharge Gas]

The type of discharge gas to be treated by the discharge gas treatment method and the discharge gas treatment device pertaining to the present embodiment is not specifically limited, and any type of gas containing chlorine gas and a perfluorocompound may be treated. The discharge gas may contain other components in addition to the chlorine gas and the perfluorocompound. For example, at least one of argon (Ar), nitrogen gas (N), oxygen gas, and water may be contained.

In the discharge gas before the treatment, the chlorine gas concentration and the perfluorocompound concentration are not specifically limited, but each concentration is preferably 0.01% by volume or more and 10% by volume or less and more preferably 0.1% by volume or more and 1% by volume or less. The total concentration of the chlorine gas and the perfluorocompound is preferably 1% by volume or less.

Examples of the discharge gas include gases discharged in production processes of compounds and gases discharged in various industrial processes. More specific examples of the discharge gas include etching gases used in a production process of semiconductors and a production process of liquid crystal display devices and cleaning gases used in a chemical vapor deposition system (CVD system). These discharge gases may contain chlorine gas and a perfluorocompound.

### [Perfluorocompound]

Perfluorocompounds are compounds containing no chlorine atoms and are a general term for compounds consisting of carbon atoms and fluorine atoms, compounds consisting of carbon atoms, hydrogen atoms, and fluorine atoms, compounds consisting of sulfur atoms and fluorine atoms, and compounds consisting of nitrogen atoms and fluorine atoms.

Specific examples of the perfluorocompound include carbon tetrafluoride (CF₄), trifluoromethane (CHF₃), hexafluoroethane (C₂F₆), 1,1-difluoroethylene (CH₂F₂), cis-1,2-difluoroethylene (CH₂F₂), trans-1,2-difluoroethylene (CH₂F₂), octafluoropropane (C₃F₈), octafluorocyclobutane (C₄F₈), octafluorocyclopentene (C₅F₈), sulfur hexafluoride (SF₆), and nitrogen trifluoride (NF₃).

### [Chlorine Gas Decomposition Step, Chlorine Gas Decomposition Unit]

Examples of the chlorine gas decomposition unit in which chlorine gas is decomposed include a reactor. When a discharge gas is introduced to a high temperature reactor and is heated, the chlorine gas decomposition step is performed.

The reactor is preferably made of a material that is inactive or poorly reactive to chlorine gas and hydrogen chloride. Examples of the material include a nickel alloy, and specific examples of the nickel alloy include inconel (registered trademark) 600, inconel (registered trademark) 601, and inconel (registered trademark) 625.

The decomposition reaction of chlorine gas is a hydrolysis reaction in which the chlorine gas in a discharge gas is thermally reacted with water, and thus the reaction is required to be performed in the presence of water. The water may be liquid water or gaseous water (water vapor) that may come into contact with the chlorine gas in a discharge gas but is typically water vapor.

When a discharge gas contains enough water, the discharge gas may be directly subjected to the chlorine gas decomposition step. When a discharge gas contains no water, the chlorine gas decomposition step is required to be performed after water is added to the discharge gas or while water is added to the discharge gas. In this case, the discharge gas treatment device pertaining to the present embodiment is required to include a water supply unit configured to add water to the discharge gas.

When a discharge gas contains insufficient water, and the discharge gas has a low water concentration, the chlorine gas decomposition step is preferably performed after water is added to the discharge gas to increase the water concentration or while water is added to the discharge gas. In this case, the discharge gas treatment device pertaining to the present embodiment preferably includes a water supply unit configured to add water to the discharge gas.

The discharge gas preferably has a water concentration of 1% by volume or more and 40% by volume or less and more preferably 10% by volume or more and 25% by volume or less. When a discharge gas has a water concentration lower than the lowest value of the above numerical range, the chlorine gas decomposition step is preferably performed after water is added to the discharge gas such that the resulting discharge gas has a water concentration higher than the lowest value of the above numerical range.

The temperature condition and the pressure condition in the chlorine gas decomposition step are not specifically limited as long as chlorine gas is thermally decomposed, but the temperature condition is preferably 700° C. or more and 900° C. or less and more preferably 700° C. or more and 850° C. or less.

The pressure condition is preferably normal pressure or pressurized conditions and more preferably normal pressure.

By subjecting a discharge gas to such a chlorine gas decomposition step, chlorine gas is decomposed, and thus the gas after the chlorine gas decomposition step has a chlorine gas concentration of 300 volume ppm or less.

Before the chlorine gas decomposition step, a discharge gas may be brought into contact with water. For example, a wet gas cleaning device (water scrubber) may be used to bring a discharge gas into vapor-liquid contact with water. Through the process, water-soluble gases are removed from the discharge gas.

### [Hydrogen Chloride Removal Step, Hydrogen Chloride Removal Unit]

The gas in which chlorine gas has been decomposed in the chlorine gas decomposition step contains hydrogen chloride. As described above, hydrogen chloride may be oxidized to regenerate chlorine gas, and thus the hydrogen chloride removal step is required to be performed to remove hydrogen chloride from the gas after the chlorine gas decomposition step.

The method of removing hydrogen chloride is not specifically limited, but the hydrogen chloride removal step is preferably a removal step of bringing the gas after the chlorine gas decomposition step into contact with water to dissolve the hydrogen chloride in the water. For example, when a wet gas cleaning device (water scrubber) is used as the hydrogen chloride removal unit, and the gas after the chlorine gas decomposition step is brought into vapor-liquid contact with water, hydrogen chloride is dissolved in the water. Accordingly, hydrogen chloride is removed from the gas after the chlorine gas decomposition step.

Alternatively, hydrogen chloride may be removed from the gas after the chlorine gas decomposition step by a method of adsorbing hydrogen chloride onto an adsorbent such as activated carbon. For example, when an adsorption column packed with an adsorbent is used as the hydrogen chloride removal unit, and the gas after the chlorine gas decomposition step is introduced to the adsorption column, hydrogen chloride is removed from the gas after the chlorine gas decomposition step.

The conditions when the water scrubber is used to remove hydrogen chloride from a discharge gas will be described. To increase the contact frequency between the discharge gas and water, a larger amount of water is preferably supplied to the water scrubber, and the amount of water supplied to the water scrubber is preferably 2.5% or more of the discharge gas flow rate. For example, when the discharge gas flow rate is 400 L/min, water is preferably supplied at 10 L/min or more.

To increase the solubility of hydrogen chloride in water, the temperature of the water supplied to the water scrubber is preferably low and is preferably 25° C. or less.

To prevent clogging in the pipe through which water is discharged from the water scrubber, a water having a low metal ion concentration is preferably supplied to the water scrubber. If a water containing metal ions such as magnesium ions or calcium ions is used, the metal ions may react with hydrogen chloride to generate a metal salt, which may cause clogging in the pipe.

### [Perfluorocompound Decomposition Catalyst]

The perfluorocompound decomposition catalyst may be any catalyst that promotes the decomposition reaction of a perfluorocompound but preferably contains, for example, nickel oxide (NiO), aluminum oxide (Al₂O₃), or a mixture thereof. The perfluorocompound decomposition catalyst preferably further contains a composite oxide containing nickel and at least one element of aluminum (Al), tungsten (W), titanium (Ti), and zirconium.

In the perfluorocompound decomposition catalyst, the mass ratio of the component elements is preferably (nickel):(aluminum):(oxygen)=(20 to 30):(30 to 40):(30 to 50).

When the perfluorocompound decomposition catalyst is a metal oxide, the catalyst also functions as the chlorine gas decomposition catalyst, and thus chlorine gas remaining in the gas after the chlorine gas decomposition step is decomposed in the perfluorocompound decomposition step.

A perfluorocompound decomposition catalyst supported on a carrier may be used to decompose a perfluorocompound, or a perfluorocompound decomposition catalyst not supported on any carrier may be directly used to decompose a perfluorocompound.

The carrier may have any shape and any size. For example, structures such as beads, pellets, powders, granules, and monoliths are preferred, and pellets are specifically preferred.

The carrier is preferably made of a porous material and may have a specific surface area of 100 cm²/g or more and 500 cm²/g or less or of 100 cm²/g or more and 300 cm²/g or less as determined by the BET method.

The carrier is preferably made of a material that is inactive or poorly reactive to chlorine gas and hydrogen chloride. Examples of the material include alumina (Al₂O₃), silica (SiO₂), cordierite, and zeolite, and alumina is preferred.

The carrier may have an average particle size (diameter) of 1 mm or more and 10 mm or less or of 2 mm or more and 5 mm or less.

### [Perfluorocompound Decomposition Step, Perfluorocompound Decomposition Unit]

Examples of the perfluorocompound decomposition unit in which a perfluorocompound is decomposed include a reactor. When the gas after the hydrogen chloride removal step is introduced to the reactor containing the perfluorocompound decomposition catalyst, the perfluorocompound decomposition step is performed.

The reactor is preferably made of a material that is inactive or poorly reactive to chlorine gas and hydrogen chloride. Examples of the material include a nickel alloy, and specific examples of the nickel alloy include inconel (registered trademark) 600, inconel (registered trademark) 601, and inconel (registered trademark) 625.

The type of decomposition reaction of the perfluorocompound is not specifically limited as long as the perfluorocompound in the gas after the hydrogen chloride removal step is decomposed. For example, the reaction may be a thermal decomposition reaction or a hydrolysis reaction with water. Examples of the hydrolysis reaction of perfluorocompounds are shown below.

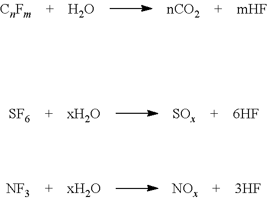

When the decomposition reaction of a perfluorocompound is a hydrolysis reaction, the perfluorocompound is required to be decomposed in the presence of water. The water may be liquid water or gaseous water (water vapor) that may come into contact with the perfluorocompound in the gas after the hydrogen chloride removal step.

When the gas after the hydrogen chloride removal step contains enough water, the gas after the hydrogen chloride removal step may be directly subjected to the perfluorocompound decomposition step. When the gas after the hydrogen chloride removal step contains no water, the perfluorocompound decomposition step is required to be performed after water is added to the gas after the hydrogen chloride removal step or while water is added to the gas after the hydrogen chloride removal step. In this case, the discharge gas treatment device pertaining to the present embodiment is required to include a water supply unit configured to add water to the gas after the hydrogen chloride removal step.

When the gas after the hydrogen chloride removal step contains insufficient water, and the gas after the hydrogen chloride removal step has a low water concentration, the perfluorocompound decomposition step is preferably performed after water is added to the gas after the hydrogen chloride removal step to increase the water concentration or while water is added to the gas after the hydrogen chloride removal step. In this case, the discharge gas treatment device pertaining to the present embodiment preferably includes a water supply unit configured to add water to the gas after the hydrogen chloride removal step.

The gas after the hydrogen chloride removal step preferably has a water concentration of 1% by volume or more and 40% by volume or less and more preferably 10% by volume or more and 25% by volume or less. When the gas after the hydrogen chloride removal step has a water concentration lower than the lowest value of the above numerical range, the perfluorocompound decomposition step is preferably performed after water is added to the gas after the hydrogen chloride removal step such that the resulting gas after the hydrogen chloride removal step has a water concentration higher than the lowest value of the above numerical range.

The temperature condition and the pressure condition in the perfluorocompound decomposition step are not specifically limited as long as the perfluorocompound is decomposed. When the decomposition reaction of the perfluorocompound is either a thermal decomposition reaction or a hydrolysis reaction, the temperature condition is preferably 300° C. or more and 1,000° C. or less, more preferably 400° C. or more and 800° C. or less, and even more preferably 500° C. or more and 800° C. or less.

When the decomposition reaction of the perfluorocompound is either a thermal decomposition reaction or a hydrolysis reaction, the pressure condition is preferably normal pressure or pressurized conditions and more preferably normal pressure.

By subjecting the gas after the hydrogen chloride removal step to such a perfluorocompound decomposition step, the perfluorocompound is decomposed at such a high decomposition rate as 99% or more, and thus the gas after the perfluorocompound decomposition step has a perfluorocompound concentration of 50 volume ppm or less relative to 1,000 to 10,000 volume ppm of the perfluorocompound concentration after the hydrogen chloride removal step.

The gas after the hydrogen chloride removal step may contain chlorine gas that has not been decomposed in the chlorine gas decomposition step. Some types of perfluorocompound decomposition catalyst may decompose the chlorine gas that has not been decomposed in the perfluorocompound decomposition step. For example, a metal oxide such as nickel oxide also functions as the chlorine gas decomposition catalyst. When a metal oxide such as nickel oxide is used as the perfluorocompound decomposition catalyst, a perfluorocompound and chlorine gas are decomposed in the perfluorocompound decomposition step. When chlorine gas is decomposed in the perfluorocompound decomposition step, the gas after the perfluorocompound decomposition step has a chlorine gas concentration of 1.0 volume ppm or less relative to 10 to 100 volume ppm of the chlorine gas concentration after the hydrogen chloride removal step.

As described above, the gas after the hydrogen chloride removal step may contain chlorine gas that has not been decomposed in the chlorine gas decomposition step, and thus a chlorine gas decomposition catalyst may be used together with the perfluorocompound decomposition catalyst in the perfluorocompound decomposition step regardless of whether or not the perfluorocompound decomposition catalyst is an effective catalyst for the decomposition of chlorine gas. In other words, the perfluorocompound decomposition unit may contain a chlorine gas decomposition catalyst together with the perfluorocompound decomposition catalyst.

When a chlorine gas decomposition catalyst is used together with the perfluorocompound decomposition catalyst in the perfluorocompound decomposition step, the perfluorocompound decomposition step is a step of decomposing the perfluorocompound in the gas after the hydrogen chloride removal step by reacting the perfluorocompound in the presence of the perfluorocompound decomposition catalyst and of decomposing the chlorine gas in the gas after the hydrogen chloride removal step by reacting the chlorine gas in the presence of the chlorine gas decomposition catalyst.

When the perfluorocompound decomposition unit contains a chlorine gas decomposition catalyst together with the perfluorocompound decomposition catalyst, the perfluorocompound decomposition unit is to decompose the perfluorocompound in the gas from which the hydrogen chloride has been removed by using the hydrogen chloride removal unit, by reacting the perfluorocompound in the presence of the perfluorocompound decomposition catalyst and is to decompose the chlorine gas in the gas from which the hydrogen chloride has been removed by using the hydrogen chloride removal unit, by reacting the chlorine gas in the presence of the chlorine gas decomposition catalyst.

By using the perfluorocompound decomposition catalyst and the chlorine gas decomposition catalyst in the perfluorocompound decomposition step, the chlorine gas that has not been decomposed in the chlorine gas decomposition step is decomposed in the perfluorocompound decomposition step. Accordingly, the gas has a much lower chlorine gas concentration.

### [Chlorine Gas Decomposition Catalyst]

The chlorine gas decomposition catalyst may be any catalyst that promotes the hydrolysis reaction of chlorine gas but preferably contains at least one of cerium oxide (CeO₂) and cobalt oxide (CoO, Co₂O₃).

The chlorine gas decomposition catalyst may contain, in addition to at least one of cerium oxide and cobalt oxide, an additional metal oxide. Examples of the additional metal oxide include at least one of aluminum oxide (Al₂O₃), magnesium oxide (MgO), chromium oxide (CrO, Cr₂O₃, CrO₂, CrO₃), manganese oxide (MnO, Mn₂O₃, MnO₂, MnO₃, Mn₂O₇), iron oxide (FeO, Fe₂O₃), nickel oxide (NiO), copper oxide (Cu₂O, CuO), and zirconium oxide (ZrO₂). In the chlorine gas decomposition catalyst, the mass ratio of the component elements is preferably (cerium):(cobalt):(copper):(aluminum):(oxygen)=(5 to 15):(5 to 15):(0.1 to 0.5):(25 to 45):(40 to 50).

The chlorine gas decomposition catalyst may contain, in addition to at least one of cerium oxide and cobalt oxide, a composite oxide of cerium (Ce) and an additional metal. Examples of the additional metal contained in the composite oxide include at least one of magnesium (Mg), chromium (Cr), manganese (Mn), iron (Fe), cobalt (Co), nickel (Ni), copper (Cu), and zirconium (Zr).

The chlorine gas decomposition catalyst may contain at least one of cerium oxide and cobalt oxide, at least one of the above additional metal oxides, and at least one of the above composite oxides.

A chlorine gas decomposition catalyst supported on a carrier may be used to decompose chlorine gas, or a chlorine gas decomposition catalyst not supported on any carrier may be directly used to decompose chlorine gas. The carrier is the same as for the perfluorocompound decomposition catalyst and is not specifically described.

After the perfluorocompound decomposition step, the gas after the perfluorocompound decomposition step may be brought into contact with water. For example, by using a wet gas cleaning device (water scrubber) to bring the gas after the perfluorocompound decomposition step into vapor-liquid contact with water, hydrogen chloride or hydrogen fluoride is removed from the gas after the perfluorocompound decomposition step. The hydrogen fluoride has been generated by the decomposition of a perfluorocompound. When hydrogen chloride or hydrogen fluoride is removed from the gas after perfluorocompound decomposition step, the main component of the detoxified gas discharged from the gas cleaning device after the perfluorocompound decomposition step is carbon dioxide (CO₂).

### EXAMPLES

The present invention will next be described more specifically with reference to examples and comparative examples.

### Example 1

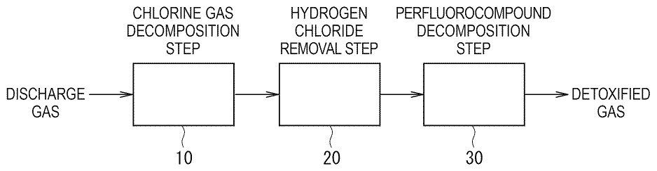

A discharge gas treatment device was used to treat a discharge gas containing chlorine gas and a perfluorocompound, detoxifying the discharge gas. The structure of the discharge gas treatment device used in Example 1 will be described with reference to the schematic diagram in FIG. 1.

The discharge gas treatment device in FIG. 1 includes a chlorine gas decomposition unit 10 that performs a chlorine gas decomposition step of decomposing chlorine gas in a discharge gas by thermally reacting the chlorine gas with water, a hydrogen chloride removal unit 20 that performs a hydrogen chloride removal step of removing hydrogen chloride from the gas after the chlorine gas decomposition step, and a perfluorocompound decomposition unit 30 that performs a perfluorocompound decomposition step of decomposing a perfluorocompound in the gas after the hydrogen chloride removal step by reacting the perfluorocompound in the presence of a perfluorocompound decomposition catalyst.

The chlorine gas decomposition unit 10 is an inconel (registered trademark) reactor (having a capacity of 70 mL). The reactor contains no catalyst, and chlorine gas is to be thermally decomposed in the reactor.

The hydrogen chloride removal unit 20 is a water scrubber.

The perfluorocompound decomposition unit 30 is an inconel (registered trademark) reactor (having a capacity of 90 mL) and is packed with 80 g of a catalyst in pellet form, 3 mm in diameter and 10 mm in length. The perfluorocompound decomposition catalyst is prepared as follows: nickel nitrate and boehmite are kneaded; and the mixture is subjected to extrusion molding and sintering. The perfluorocompound decomposition catalyst is a mixture of nickel oxide (NiO) and aluminum oxide (Al₂O₃), and the mass ratio of the component elements is nickel:aluminum:oxygen=23:37:40.

In the discharge gas treatment device in FIG. 1, a discharge gas is introduced to the chlorine gas decomposition unit 10 to be subjected to the chlorine gas decomposition step, and the chlorine gas in the discharge gas is thermally decomposed. The gas after the chlorine gas decomposition step is discharged from the chlorine gas decomposition unit 10 and is introduced to the hydrogen chloride removal unit 20.

In the hydrogen chloride removal unit 20, the hydrogen chloride removal step is performed to remove the hydrogen chloride in the gas after the chlorine gas decomposition step.

The gas after the hydrogen chloride removal step is discharged from the hydrogen chloride removal unit 20 and is introduced to the perfluorocompound decomposition unit 30. In the perfluorocompound decomposition unit 30, the perfluorocompound decomposition step is performed to hydrolyze the perfluorocompound and the chlorine gas in the gas after the hydrogen chloride removal step. The gas from which the chlorine gas and the perfluorocompound have been removed is discharged as a detoxified gas from the perfluorocompound decomposition unit 30.

The discharge gas to be treated with the discharge gas treatment device illustrated in FIG. 1 has the following composition. In other words, the discharge gas is a mixed gas of chlorine gas, octafluorocyclobutane, nitrogen gas, water vapor, and oxygen gas, and the volume ratio is chlorine gas:octafluorocyclobutane:nitrogen gas:water vapor:oxygen gas=0.5:0.5:82:15:2.

Specifically, chlorine gas, octafluorocyclobutane, nitrogen gas, and air were mixed at the above volume ratio while each volume was controlled with a mass flow controller, and the mixture was introduced to the chlorine gas decomposition unit 10 under normal pressure. Meanwhile, pure water at normal temperature was introduced to a preheater (not illustrated) and was vaporized at 400° C., and the resulting water vapor was introduced to the chlorine gas decomposition unit 10 such that the mixed gas of chlorine gas, octafluorocyclobutane, nitrogen gas, water vapor, and oxygen gas had the above volume ratio. The mixed gas of chlorine gas, octafluorocyclobutane, nitrogen gas, water vapor, and oxygen gas was supplied to the chlorine gas decomposition unit 10 at a rate of 5 L/min in terms of standard conditions (0° C., 1.01×10⁵ Pa).

As described above, while the mixed gas (discharge gas) was supplied to the chlorine gas decomposition unit 10, the chlorine gas was decomposed in the chlorine gas decomposition unit 10 at 750° C. At the point where the chlorine gas had been decomposed for 1 hour, the mixed gas (discharge gas) supplied to the chlorine gas decomposition unit 10 and the gas discharged from the chlorine gas decomposition unit 10 were sampled, and the concentrations of chlorine gas, octafluorocyclobutane, and hydrogen chloride in each gas were measured. Table 1 shows the result. In Table 1, octafluorocyclobutane is abbreviated as “PFC”.

TABLE 1

| | | | | | | | Gas discharged |
|---|---|---|---|---|---|---|---|
| | | | | Gas discharged from chlorine | | | from hydrogen |
| | Discharge gas | | | gas decomposition unit | | | chloride removal unit |
| | Cl₂ | HCl | PFC | Cl₂ | HCl | PFC | Cl₂ |
| | concentration | concentration | concentration | concentration | concentration | concentration | concentration |
| Ex. 1 | 5000 | 0 | 5000 | 196 | 9600 | 5000 | 196 |
| Ex. 2 | 5000 | 0 | 5000 | 196 | 9600 | 5000 | 196 |
| Ex. 3 | 5000 | 0 | 5000 | 43 | 9914 | 5000 | 43 |
| Comp. Ex. 1 | 5000 | 0 | 5000 | 196 | 9600 | 5000 | — |
| Comp. Ex. 2 | 5000 | 0 | 5000 | 196 | 9600 | 5000 | — |

| | Gas discharged from hydrogen | | Detoxified gas | | | |
|---|---|---|---|---|---|---|
| | chloride removal unit | | | Cl₂ | | PFC |
| | HCl | PFC | Cl₂ | detoxification | PFC | detoxification |
| | concentration | concentration | concentration | rate | concentration | rate |
| Ex. 1 | 0 | 5000 | 0.7 | 99.99 | 17.0 | 99.66 |
| Ex. 2 | 0 | 5000 | 0.5 | 99.99 | 24.5 | 99.51 |
| Ex. 3 | 0 | 5000 | 0 | 100 | 29.0 | 99.42 |
| Comp. Ex. 1 | — | — | 132 | 97.36 | 25.5 | 99.49 |
| Comp. Ex. 2 | — | — | 196 | 96.08 | 5000 | 0 |

* The units of the values are volume ppm for concentration and % for detoxification rate.

The measurement method of the chlorine gas concentration in a gas will be described below. A gas (a discharge gas to be supplied to the chlorine gas decomposition unit 10 or a gas discharged from the chlorine gas decomposition unit 10) was allowed to pass through 100 g of 1.0% by mass aqueous potassium iodide solution for 15 min. The aqueous potassium iodide solution through which the gas had passed was then titrated by the iodometric titration method, and the amount of chlorine gas in the gas was calculated.

The measurement method of the octafluorocyclobutane concentration in a gas will be described below. In other words, 1 cm³ of an analyte gas was sampled with a syringe and was injected into a gas chromatograph (manufactured by Shimadzu Corporation, GC-14B, detector: TCD) to which various factors had been input for quantitative analysis of the concentration of the analyte gas, and the concentration was determined.

The hydrogen chloride concentration in a gas was measured by the following two methods for a gas after the chlorine gas decomposition step and for a gas after the hydrogen chloride decomposition step described later.

For an analyte gas containing no chlorine gas, a detector-tube gas measurement device including a hydrogen chloride detector tube (manufactured by GASTEC, hydrogen chloride 14L) and a gas sampler (manufactured by GASTEC, GV-100) was used to measure the hydrogen chloride concentration in the gas. In other words, the detector-tube gas measurement device was used to suck a certain volume (500 mL) of a gas, and from the discolored length of the detector tube through which the gas had passed, the hydrogen chloride concentration was measured (hereinafter called “method A”).

For an analyte gas containing chlorine gas, the method A cannot be used because chlorine gas interferences with the detection of hydrogen chloride. Hence, the chlorine gas concentration was determined by the above iodometric titration method. The difference between the chlorine gas concentration before the step and the chlorine gas concentration after the step was assumed to have been converted to hydrogen chloride, and the hydrogen chloride concentration was calculated (hereinafter called “method B”).

The hydrogen chloride concentration in the gas after the chlorine gas decomposition step was determined by the method B because the analyte gas contained chlorine gas.

The hydrogen chloride concentration in the gas after the hydrogen chloride removal step was calculated as follows: a gas containing only hydrogen chloride and nitrogen gas was subjected to the hydrogen chloride removal step; the reduction rate of the hydrogen chloride concentration was determined by the method A; and the reduction rate was multiplied by the hydrogen chloride concentration in the gas after the chlorine gas decomposition step.

Next, the gas discharged from the chlorine gas decomposition unit 10 was supplied to the hydrogen chloride removal unit 20 (water scrubber), and hydrogen chloride was removed in the hydrogen chloride removal unit 20. The gas discharged from the chlorine gas decomposition unit 10 was supplied to the hydrogen chloride removal unit 20 at a rate of 5 L/min in terms of standard conditions, and water was supplied at a rate of 0.5 mL/min. The water supplied to the hydrogen chloride removal unit 20 had a temperature of 25° C.

At the point where the hydrogen chloride had been removed for 1 hour, the gas discharged from the hydrogen chloride removal unit 20 was sampled, and each concentration of chlorine gas, octafluorocyclobutane, and hydrogen chloride in the gas was determined. Table 1 shows the result. The measurement methods of chlorine gas, octafluorocyclobutane, and hydrogen chloride were the same as above.

Next, while the gas discharged from the hydrogen chloride removal unit 20 was supplied to the perfluorocompound decomposition unit 30, the perfluorocompound and the chlorine gas were decomposed in the perfluorocompound decomposition unit 30 at 750° C.

At the point where the perfluorocompound and the chlorine gas had been decomposed for 1 hour, the detoxified gas discharged from the perfluorocompound decomposition unit 30 was sampled, and each concentration of chlorine gas, octafluorocyclobutane, and hydrogen chloride in the gas was determined. Table 1 shows the result. The measurement methods of chlorine gas, octafluorocyclobutane, and hydrogen chloride were the same as above.

The measurement result of the chlorine gas concentration in the detoxified gas was substituted into the following formula to calculate the detoxification rate of chlorine gas. For the octafluorocyclobutane, the detoxification rate was calculated in a similar manner to the chlorine gas. Table 1 shows the result.

$$Detoxification rate ( \% ) = \{ ( 0.5 - chlorine gas concentration in detoxified gas ( \% by volume ) ) \text{} / 0.5 \} \times 100$$

### Example 2

The perfluorocompound decomposition unit 30 was packed with 11 g of a chlorine gas decomposition catalyst in pellet form, 3.2 mm in diameter and 10 mm in length, and with 64 g of the same type of perfluorocompound decomposition catalyst as that used in Example 1. Except for this, a discharge gas was treated in the same manner as in Example 1. Table 1 shows the result.

The chlorine gas decomposition catalyst was prepared as follows: cerium nitrate, cobalt nitrate, copper nitrate, and boehmite were kneaded; and the mixture was subjected to extrusion molding and sintering. The chlorine gas decomposition catalyst was a mixture of cerium oxide (CeO₂), cobalt oxide (CoO), copper oxide (CuO), and aluminum oxide (Al₂O₃), and the mass ratio of the component elements was cerium:cobalt:copper:aluminum:oxygen=11.8:7.5:0.2:36.0:44.5.

### Example 3

The discharge gas was treated in the same manner as in Example 1 except that the chlorine gas was decomposed in the chlorine gas decomposition unit 10 at a temperature of 850° C. Table 1 shows the result.

### Comparative Example 1

The discharge gas was treated in the same manner as in Example 2 except that the discharge gas treatment device included no hydrogen chloride removal unit 20, and the gas discharged from the chlorine gas decomposition unit 10 was supplied to the perfluorocompound decomposition unit 30. Table 1 shows the result. As revealed from Table 1, Comparative Example 1 was unable to sufficiently reduce the chlorine gas concentration in the detoxified gas as compared with Examples 1 and 2.

### Comparative Example 2

The discharge gas was treated in the same manner as in Example 1 except that the discharge gas treatment device included neither the hydrogen chloride removal unit 20 nor the perfluorocompound decomposition unit 30 but included only the chlorine gas decomposition unit 10. In other words, while a discharge gas was supplied to the chlorine gas decomposition unit 10, chlorine gas was thermally decomposed in the chlorine gas decomposition unit 10 at 750° C.

At the point where the chlorine gas had been decomposed for 1 hour, the gas discharged from the chlorine gas decomposition unit 10 was sampled as the detoxified gas, and each concentration of chlorine gas, octafluorocyclobutane, and hydrogen chloride in the gas was determined. Table 1 shows the result. The measurement methods of chlorine gas, octafluorocyclobutane, and hydrogen chloride were the same as above.

As revealed from Table 1, Comparative Example 2 was unable to sufficiently reduce the chlorine gas concentration in the detoxified gas as compared with Examples 1 and 2.

### REFERENCE SIGNS LIST

10: chlorine gas decomposition unit
20: hydrogen chloride removal unit
30: perfluorocompound decomposition unit

1. A method of treating a discharge gas containing chlorine gas and a perfluorocompound, the discharge gas treatment method comprising:
a chlorine gas decomposition step of decomposing the chlorine gas in the discharge gas by thermally reacting the chlorine gas with water;
a hydrogen chloride removal step of removing hydrogen chloride from a gas after the chlorine gas decomposition step; and
a perfluorocompound decomposition step of decomposing the perfluorocompound in a gas after the hydrogen chloride removal step by reacting the perfluorocompound in the presence of a perfluorocompound decomposition catalyst.

2. The discharge gas treatment method according to claim 1, wherein the perfluorocompound decomposition step is a step of decomposing the perfluorocompound in the gas after the hydrogen chloride removal step by reacting the perfluorocompound in the presence of the perfluorocompound decomposition catalyst and of decomposing the chlorine gas in the gas after the hydrogen chloride removal step by reacting the chlorine gas in the presence of a chlorine gas decomposition catalyst.

3. The discharge gas treatment method according to claim 1, wherein the hydrogen chloride removal step is a step of removing the hydrogen chloride by bringing the gas after the chlorine gas decomposition step into contact with water to dissolve the hydrogen chloride in the water.

4. The discharge gas treatment method according to claim 1, wherein in the chlorine gas decomposition step, the chlorine gas is reacted and decomposed at a temperature of 700° C. or more and 850° C. or less.

5. The discharge gas treatment method according to claim 1, wherein in the perfluorocompound decomposition step, the perfluorocompound is reacted and decomposed at a temperature of 500° C. or more and 800° C. or less.

6. A device of treating a discharge gas containing chlorine gas and a perfluorocompound, the discharge gas treatment device comprising:
a chlorine gas decomposition unit configured to decompose the chlorine gas in the discharge gas by thermally reacting the chlorine gas with water;
a hydrogen chloride removal unit configured to remove hydrogen chloride from a gas in which the chlorine gas has been decomposed by using the chlorine gas decomposition unit; and
a perfluorocompound decomposition unit containing a perfluorocompound decomposition catalyst, the perfluorocompound decomposition unit being configured to decompose the perfluorocompound in a gas from which the hydrogen chloride has been removed by using the hydrogen chloride removal unit, by reacting the perfluorocompound in the presence of the perfluorocompound decomposition catalyst.

7. The discharge gas treatment device according to claim 6, wherein the perfluorocompound decomposition unit contains the perfluorocompound decomposition catalyst and a chlorine gas decomposition catalyst and is configured to decompose the perfluorocompound in the gas from which the hydrogen chloride has been removed by using the hydrogen chloride removal unit, by reacting the perfluorocompound in the presence of the perfluorocompound decomposition catalyst and to decompose the chlorine gas in the gas from which the hydrogen chloride has been removed by using the hydrogen chloride removal unit, by reacting the chlorine gas in the presence of the chlorine gas decomposition catalyst.

8. The discharge gas treatment device according to claim 6, wherein the hydrogen chloride removal unit is configured to remove the hydrogen chloride by bringing the gas in which the chlorine gas has been decomposed by using the chlorine gas decomposition unit, into contact with water to dissolve the hydrogen chloride in the water.

9. The discharge gas treatment device according to claim 6, wherein the chlorine gas decomposition unit is configured to react and decompose the chlorine gas at a temperature of 700° C. or more and 850° C. or less.

10. The discharge gas treatment device according to claim 6, wherein the perfluorocompound decomposition unit is configured to react and decompose the perfluorocompound at a temperature of 500° C. or more and 800° C. or less.

11. The discharge gas treatment method according to claim 2, wherein the hydrogen chloride removal step is a step of removing the hydrogen chloride by bringing the gas after the chlorine gas decomposition step into contact with water to dissolve the hydrogen chloride in the water.

12. The discharge gas treatment method according to claim 2, wherein in the chlorine gas decomposition step, the chlorine gas is reacted and decomposed at a temperature of 700° C. or more and 850° C. or less.

13. The discharge gas treatment method according to claim 2, wherein in the perfluorocompound decomposition step, the perfluorocompound is reacted and decomposed at a temperature of 500° C. or more and 800° C. or less.

14. The discharge gas treatment device according to claim 7, wherein the hydrogen chloride removal unit is configured to remove the hydrogen chloride by bringing the gas in which the chlorine gas has been decomposed by using the chlorine gas decomposition unit, into contact with water to dissolve the hydrogen chloride in the water.

15. The discharge gas treatment device according to claim 7, wherein the chlorine gas decomposition unit is configured to react and decompose the chlorine gas at a temperature of 700° C. or more and 850° C. or less.

16. The discharge gas treatment device according to claim 7, wherein the perfluorocompound decomposition unit is configured to react and decompose the perfluorocompound at a temperature of 500° C. or more and 800° C. or less.
